(19) United States
(12) Patent Application Publication
(10) Pub. No.: US 2002/0159574 A1
(43) Pub. Date: Oct. 31, 2002

(54) Automatic telephone directory apparatus and method of operation thereof

(76) Inventor: Scott Stogel, Westport, CT (US)

Correspondence Address: MARK UNGERMAN, FULBRIGHT & JAWORSKI L.L.P., 801 PENNSYLVANIA AVENUE, N.W., WASHINGTON, DC, 20004-2615, US

(21) Appl. No.: 09/842,774

(22) Filed: Apr. 27, 2001

(51) Int. Cl. H04M 11/00

(52) U.S. Cl. 379/93.01; 379/93.25

(57) ABSTRACT

A telephone directory system includes an interface adapted for connecting to a subscriber line of a telephone network (e.g., a local loop.) A dialing signal decoder receives a dialing signal from the interface to provide dialed number information such as DTMF signaling generated by a telephone used to initiate an outgoing call. For incoming calls, a calling number identification decoder (e.g., caller-ID or ANI device) receives a calling number signal from the interface to provide calling number information. A controller processes the dialed and calling number information and, in response, issues a query to a remote database for information associated with at least one of the dialed and calling number information. A memory may be used to store a directory including the dialed and calling number information together with any associated information such as the names of the called and/or called parties associated with the stored telephone numbers.

### BACKGROUND OF THE INVENTION

1. Field of the Invention

The invention relates to an automatic telephone number directory system and, more particularly, to an intelligent, personal telephone directory system having access to remote data bases and resources.

2. Background of the Invention

Advances in computer systems and microprocessor technology has prompted a transition from paper records to electronically stored data. Many if not most modestly priced telephones typically include a small memory for storing the most frequently used telephone numbers manually programmed by the user. Often, these telephones will further remember the last dialed telephone number for one button redialing. More robust telephone directories are often stored on personal computers and, increasingly, on handheld electronic telephone directories and personal digital assistant (PDAs.) Again, entry of names, telephone numbers and related information is typically a manual process initiated by the user or, occasionally, prompted by an application. In addition, some of these platforms, such as is the case with many personal computer, have the capability of dialing a number selected from stored a telephone directory, typically using a built-in or external data modem.

In addition to personally stored telephone numbers, access is now available to a wide range of commercial databases including name and telephone numbers. For example, using the resources of the World Wide Web (WWW) of the Internet, services such as Anywho, Switchboard, Yahoo(.com) and others provide nationwide telephone listings for both residential (white pages) and businesses (yellow pages.) Many of these services also provide reverse listings to identify a caller based on telephone number. A user may use these services to search for a telephone number and, if desired, enter the information from the remote telephone directory into a personal telephone directory of numbers most frequently referenced.

While personal directories provide a custom listing of contact information including names, addresses and telephone numbers for initiating a call, telephone numbers are also used as identification. Thus, businesses often store customer information keyed to customer telephone number. With the provision of CNID Calling Number Identification (herein used interchangeably with calling line identification, or CLID, to mean any data associated with an incoming call identifying a telephone or line number associated with the originator of the call) in the form of ANI (Automatic Number Identification) and caller-ID, businesses and residential subscribers can receive the telephone number of an incoming call. (Although these services differ slightly, all provide a 10 digit telephone number associated with the incoming telephone call. Thus, in the case of caller ID, the ten-digit trunk number of the calling party is provided as an FSK signal on a standard POTS (plain old telephone service) line while ANI provides the billing telephone number (BTN) of the caller on a digital T1 or PRI in a DTMF or MF, or inband signaling protocol.) In addition to the ten-digit telephone number, the caller name or line owner may be supplied to a subscriber by the terminating switch by making a query to a database with phone numbers and corresponding names (e.g., as listed in a Calling Name (CNAM) database). This information may then be displayed by suitable customer premises equipment (CPE) such as a caller-ID display. In the case of caller-ID, this information may be supplied during the period between the first and second ring signal for an initial call (see, for example, U.S. Pat. Nos. 4,551,581 and 4,582,956 of Doughty) or, if the called line includes a call waiting feature, after the call waiting tone is sent (i.e., caller-ID with call waiting or CIDCW.) When a call from a third party is received at a switch for a line with CIDCW, a subscriber access signal (SAS) tone followed by a CPE alerting signal (CAS) tone is transmitted by the switch onto the called line. In response to the CAS tone, CPE transmits back to the switch an acknowledge signal and mutes the subscribers telephone. The switch also mutes the acknowledge signal and, in response, transmits the third party's caller-ID information. Upon receipt of the information, the number and possibly name of the third party caller is displayed and communication is re-established with the second party. The called party may then use conventional call waiting protocol to answer the call from the third party and, if desired, switch between calls. Such as system is described, for example, in U.S. Pat. No. 5,263,084 to Chaput, et al. with a system accommodating multiple off-hook extension telephones further described in U.S. Pat. No. 5,745,557 of Anglikowski and U.S. Pat. Nos. 5,574,777 and 5,583,924 of Lewis.

In addition to display of incoming call information, some CPE tracks outgoing and/or incoming calls and stores respective called and calling party data into a directory. For example, U.S. Pat. No. 4,924,496 of Figa describes an incoming telephone number display system that detects the caller's telephone number and compares that number with telephone numbers stored in a directory to identify and display the name and telephone number of the caller. The patent further describes that the system may log incoming and outgoing telephone calls, their duration, and time and date of those calls. U.S. Pat. No. 4,304,968 of Klausner et al. describes a telephone electronic answering device (TEAD) that monitors a dialed telephone number, searches its memory to associate the telephone number with a name, and records the caller's name, telephone number and time of call in the memory.

In U.S. Pat. No. 6,005,927, Rahrer, et al. describes an electronic telephone directory that can outdial calls and store, in a personal directory, the telephone numbers and names of both the outdialed and incoming calls. In the case of incoming calls, name information is captured with a calling line identification (CLID) receiver while, in the case of outdialed calls, the apparatus may initiate a query to the telephone network for the name of a party associated with the dialed telephone number.

While the prior art systems discussed above provide for a CPE device including a telephone directory populated, at least in part, in response to calls dialed by the device and ANI or caller-ID signals received in connection with incoming calls, these devices do not synchronize distributed databases that may be used by a subscriber as maintained by multiple devices such as, for example, home and office telephones, cellular telephone, computer dialer, etc. Nor do the prior art systems include robust means for collecting call related data other than data that is supplied at the time of the call.

### SUMMARY OF THE INVENTION

It is an object of the invention to provide an automated telephone directory system and a method of operating the same which monitors both incoming and outgoing calls to compile and update a database of telephone numbers and associated name information. The system periodically searches one or more remote databases to obtain name and/or other information related to each of the telephone numbers. It is a further object of the invention to update and synchronize one or more personal telephone directories with said database of telephone numbers and associated name information. It is a further object of the invention to provide voice recognition of information to be stored in the database in association with a telephone call, such as a telephone number being called or a name of a called or calling party associated with a telephone call. It is a further object of the invention to allow any telephone and/or caller-ID device on a given subscriber line to take advantage of a single automated telephone directory system. It is a further object of the invention to provide a system which may be installed either at a central switching location or in the location of the telephones. These objects are achieved by a telephone directory system and method which monitors a telephone line for telephone numbers and caller name information associated with incoming calls and telephone numbers of outgoing calls, stores the information in a database, and, either periodically or as required, retrieves name and/or other data associated with the telephone numbers from a remote database of telephone listings.

According to one aspect of the invention, a method of managing a database includes monitoring telephone signals on a subscriber telephone line and extracting therefrom telephone number data associated with respective telephone calls. Upon completion of the calls, a search is initiated of a remote database containing identification data associated with the telephone number data. Identification data (e.g., name, address, circuit identifier, URL, etc.) in association with the telephone number data is then stored in a directory According to a feature of the invention, the directory may be searched for the identification data and, in response to an absence thereof (i.e., if not found or missing), the recited search of the remote database is initiated. Monitoring telephone signals on the subscriber line may include (i) detecting a caller-ID signal of an incoming one of the calls and (ii) detecting a dialing signal associated with an outgoing one of the calls.

According to another feature of the invention, multiple telephone numbers are accumulated (e.g., those lacking name information are queued) to form the telephone number data. Availability of a communications link with the remote database is assessed to see if the link is available for use. The telephone number data is then transmitted to the remote database on the link and, in response, identification data is received back from the remote database. The remote database may be maintained on the user's premises, preferably connected to a LAN in common with the directory. Alternatively, by way of further example, the remote database may be maintained by a third party vendor, such as a Line Information Database (LIDB) or Calling Name (CNAM) database maintained by a local telephone company or hub provider on a Service Control Point (SCP). The identification data is then received from the remote database and, preferably, reassociated with the appropriate telephone number.

According to another feature of the invention, searching of the remote data base may be subdivided into several operations. Initially, a query message is formulated based on the number data. For example, the message may be formatted using TCAP (Transactions Capabilities Part) Protocol to access an SCP or using HTTP (hypertext transfer protocol) for transmission to a service available on the Internet. The query is then transmitted to the remote data base and, in response, a reply is received including the identification data.

According to another feature of the invention, an incoming one of the calls is detected, for example, by detection of a ringing signal, an ISUP message, etc. Calling party number information in the form of either caller-ID (e.g., analog loop) or an ANI message (e.g., ISDN service) is transmitted and then decoded in association with the incoming call. Upon detection of an outgoing call (e.g., in response to and off-hook condition such as loop current, receipt of dial tone, ISUP message, etc.) a dialed signal associated with the outgoing call is decoded so as to permit extraction of called number information.

According to another feature of the invention, a second database is synchronized or updated to agree with the identification and telephone number data stored in the directory. Thus, multiple databases and directories maintained by a user contain the similar lists of telephone numbers and related data. Synchronization may take into account predefined distinctions between or among the databases or directories. Thus, for example, a directory stored in a cellular telephone may have insufficient memory to store all data in a home based directory so that the cellular database may be a selected subset of the home directory.

According to another feature of the invention, voice dialing and commands are accommodated by recognizing a voice segment spoken on the telephone line and decoding of the voice segment to extract telephone number data.

According to another feature of the invention, the identification data and the telephone number data are displayed. The display may be local or at a remote location, such as at a caller-ID display or appropriate primary or extension telephone. For example, updated information may be transmitted to caller-ID displays connected to the subscriber's line as implemented by CIDCW.

According to another aspect of the invention, a telephone directory system includes an interface adapted for connecting to a subscriber line of a telephone network (e.g., a local loop.) As used herein, the phrase “telephone network” may be broadly construed to include the Public Switched Telephone System (PSTN) including voice, data, signaling and control network components, and other of telecommunications facilities such as Voice Over IP (VoIP) capabilities of the Internet. A dialing signal decoder receives a dialing signal from the interface to provide dialed number information. For example, DTMF dialing signals generated by a telephone used to initiate an outgoing call to a distant called party, the DTMF signaling being transmitted onto the subscriber line, detected and decoded to obtain the dialed telephone number. For incoming calls, a calling number identification decoder (e.g., caller-ID or ANI device) receives a calling number signal from the interface to provide calling number information. A controller or processor receives the dialed and calling number information and, in response, issues a query to a remote database for identification information associated with at least one of the dialed and calling number information. A memory may be used to store a directory including the dialed and calling number information together with any associated identification information. The memory may be, for example, a nonvolatile semiconductor memory device, a disk drive, etc.

According to a feature of the invention, the system is connected to a data network so that the processor is capable of transmitting a query to a remote database connected to or accessible via the data network. A display may be connected to the processor and configured to display the dialed and calling number information together with any associated identification information such as calling or called party name(s). According to another feature of the invention, the processor is responsive to the calling -number signal so as to initiate a search of its memory for the identification information. The interface with the subscriber line and/or the “telephone network” may include an appropriate demarcation point such as a network interface device (NID). The dialing signal decoder may include a DTMF receiver/decoder to obtain the telephone number of an outgoing call, while the the calling number identification decoder used to identify a telephone number of an incoming call may be, for example, a caller-ID or ANI compatible device.

According to anther feature of the invention, the dialed and calling number information each include telephone numbers of called and calling parties on the voice telephone network, the identification information including names associated with at least one of the called and calling parties.

According to another feature of the invention, a display is included to display to a user the telephone numbers of the called and calling parties together with any associated name information. The system may be connected to a packet data network, such as a LAN, WAN or the Internet, to provide access to the remote database. A lines status detector may be included and used to determine whether the subscriber line is available (e.g., idle, all telephones “onhook”) for initiating a call to the remote database.

According to another feature of the invention, the directory system includes its own call-ID compatible modulator (or modem) configured to transmit the name to a remote caller-ID receiver.

According to another aspect of the invention, a telephone number database device includes a DTMF receiver/decoder connected to a subscriber line to provide called number data in connection with outgoing calls. A caller-ID receiver/decoder is also connected to the subscriber line to provide calling number and name data of incoming calls. To automatically obtain name information associated with outgoing calls or for incoming calls where either (i) no name information is available or (ii) the name information is subject to verification or correction, a data modem is used to communicate with a remote network including a remote database of telephone numbers and associated names. A controller (e.g., processor) stores the called and calling number data and the name data in a memory, the controller being responsive to detection of a telephone call on the subscriber line for searching the memory for the name data corresponding to the telephone call. The controller is further configured to transmit a query to the remote database for name information associated with the call.

### BRIEF DESCRIPTION OF THE DRAWINGS

FIG. 1 is a block diagram of a telephone directory system located at a telephone customer's premises and connected to the Public Switched Telephone Network.

FIG. 2 is a flow diagram of processing for monitoring a telephone line for incoming and outgoing telephone calls to obtain telephone and name information.

FIG. 3 is a flow diagram of processing for synchronizing a local phone directory using a remote database.

### DETAILED DESCRIPTION OF THE PREFERRED EMBODIMENT

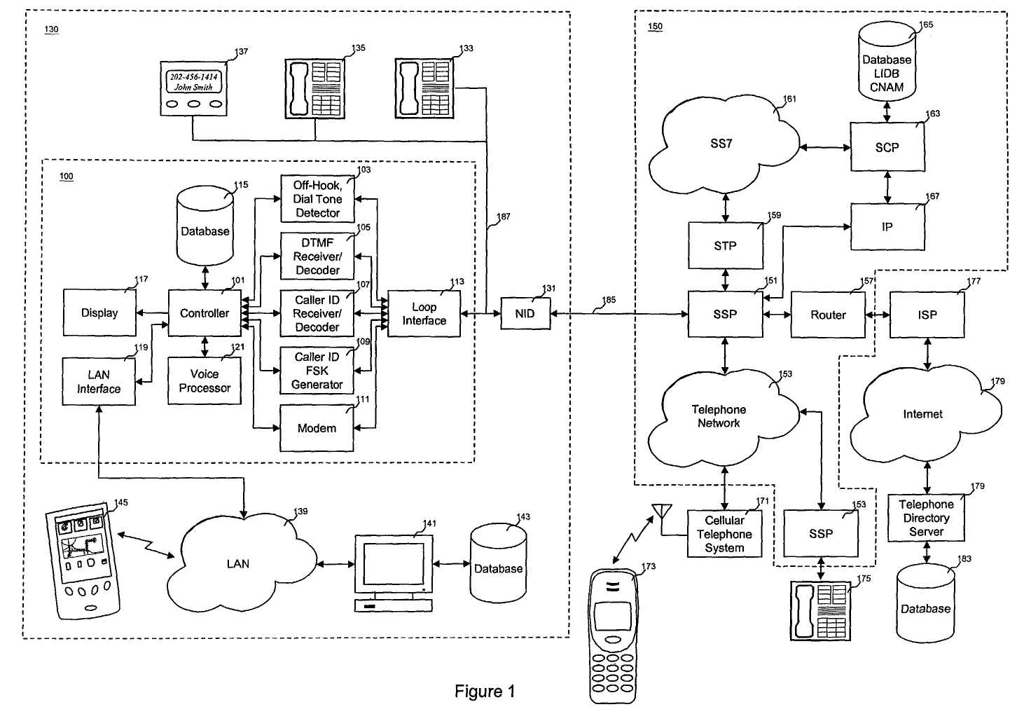

Referring to FIG. 1, an Automatic Telephone Directory Apparatus (ATDA) 100 is located at customer premises 130. Premises 130 may be a residence, commercial establishment, service facility, or space provided at a telephone central switching office. ATDA 100 includes a Controller 101 preferably implemented by a software programmable micro processor. An appropriate program for execution by controller 101 may be stored in internal memory or loaded from an external source such as server 141. Controller 101 is connected to dedicated receiver, detector, decoder and modem facilities 103-111 for monitoring signaling and data on subscriber telephone line 187, synchronizing with a remote database 183 and providing telephone customer name and related information from database 143 to local display 137. Although the functional capabilities depicted in blocks 103-111 may be implemented as discreet hardware devices, software or firmware implementations may be implemented by or separate from Controller 101.

Specifically, Controller 101 is connected to offhook/dial tone detector 103 to initiate capture of an out dialed telephone number. Detection of an off hook condition and/or dial tone is desirable to limit DTMF decoding to call initiation and avoid handling subsequent DTMF signaling after dialing or errors associated with subsequent spurious signals that might be confused as DTMF. Offhook/dial tone detector 103 may also be included as part of modem 111 to enable connection with a remote database, to be described. Alternatively, dial tone detector 103 may be replaced by other circuitry indicating an off-hook condition prompting capture of outgoing DTMF or other dialing signaling representing a dialed telephone number, e.g., ISDN D channel signals.

Controller 101 is likewise connected to DTMF receiver/decoder 105 for receiving and decoding DTMF signaling associated with an outgoing telephone call. When dial tone detector 103 or an equivalent is included, Controller 101 signals DTMF receiver/decoder 105 to begin capture and decoding of DTMF signaling upon call initiation. DTMF receiver/decoder 105 may also be used to provide remote control of ATDA 101 such as to provide for auto dialing of a previously stored telephone number. Other forms of dialed number detection may be used as appropriate to other telephone services such as ISDN, DSL, VoIP, etc.

Caller ID receiver/decoder 107 is connected to Controller 101 to provide the telephone number and, when available, name information associated with an incoming call. The caller ID information may be provided by the telephone service provider as a FSK (frequency shift keyed) signal during the period between first and second ring signals of an incoming call or during a call in progress when caller-ID with call waiting (CIDCW) service is provided. In either case, the caller ID information is provided by caller ID receiver/decoder 107 to Controller 101 in connection with incoming telephone calls. Thus DTMF receiver/decoder 105 provides telephone numbers of outgoing calls made from subscriber line 187 while caller ID receiver/decoder 107 provides telephone numbers and names, when available, in connection with incoming calls.

Controller 101 is also connected to a caller ID FSK (frequency shift keyed) generator 109 used to transmit pre-stored telephone numbers and names to local caller-ID display 137 by, for example, generating appropriate CIDCW signaling.

Modem 111 is also connected to Controller 101 to provide access to remote data networks such as the Internet. To the extent available, modem 111 may also be used to retrieve data from databases maintained by a hub provider such as a local telephone service provider.

Loop interface 113 connects devices 103-111 to customer premises wiring of telephone line 187 and network interface device (NID) 131, the latter being a demarcation point between customer premises equipment and facilities of the local telephone service provider.

Database 115 of a ATDA 100 stores a directory of telephone numbers, associated names and other information either manually entered or, preferably, captured from incoming and outgoing telephone calls according to the invention. The information in database 115 is supplemented and updated by Controller 101 using remote resources such as a calling name database maintained by the telephone service provider 150, commercial telephone listings and directories available on remote networks such as the Internet 179, and by accessing other equipment and systems of the subscriber, such as telephone numbers and names stored in cellular telephone 173.

Display 117 provides a visual indication of telephone numbers, names and any related information stored in database 115, detected by DTMF receiver/decoder 105 and/or received by caller ID receiver/decoder 107. Related information may include, for example, address information associated with a telephone number, alternative telephone numbers, history of calls made to and received from the indicated telephone number, time and length of calls, etc. Display 117 may further be used to provide status indicators, prompts and other information to the user. According to one embodiment of the invention, display 117 may be touch sensitive to provide user control of an input to a ADTA 100. For example, the user may use a touch sensitive version of display 117 to input name and related information in connection with a telephone number for storage in database 115, select directory listings from database 115, and initiate out dialing of a selected entry. Alternatively or in addition, a conventional alphanumeric keyboard may be used to input such information.

Local area network (LAN) interface 119 connects to Controller 101 to provide connectivity with LAN 139 and devices and networks connected thereto. For example, server 141 and associated database 143 of telephone numbers may be accessed by ATDA 100 on LAN 139 to obtain name and address information required to supplement telephone numbers stored in ATDA database 115. Server 141 may also be used to control and supervise operation of a ATDA 100.

Also accessible to ATDA 100 on LAN 139 are various wireless devices and portable units such as personal digital assistant (PDA) 145. Wireless connectivity with DPA 145 using, for example, USB, IRDA or a blue tooth connection, is desirable to synchronize personal directory information maintained by the PDA 145 with the contents of database 115.

Telephones 133 and 135 are also located at customer premises 130 and are connected to inside wiring of telephone line 187, in parallel with ATDA 100. Telephones 133 and 135 may be conventional telephone sets either one possibly being co-located with, or incorporated into, ATDA 100. According to an alternative embodiment of the invention (not shown) ATDA 100 is incorporated and integrated into a telephone. Further, multiple ATDAs 100 may be provided at customer premises 130, each being positioned near or incorporated into telephones at or in which direct access to a personal telephone directory is needed or desired. Alternatively, or in addition, remotely located extension telephones may be provided with caller ID displays 137, ATDA 100 being configured to cause the display of name and telephone number information by, for example, generating appropriate CIDCW signaling.

CIDCW signaling may be used to provide the remote display of information retrieved from database 115 in cases, for example, where no caller ID name information is available for an incoming call or when a user requests supplemental information using, for example, DTMF signaling from telephone 133 or 135. In these cases, controller 101 transmits the information by causing caller ID FSK generator 109 to transmit a SAS (subscriber alert signal) tone followed by a CPE alerting signal (CAS) tone to inside wiring of telephone line 187. In response, caller ID display 137 returns an acknowledgment signal defined as DTMF signal “D”. The acknowledged signal causes telephones 133 and 135 to temporarily mute so that a user would not hear the acknowledged signal or subsequent signaling. A similar capability may be incorporated into NID 131 such that line 185 is disconnected and, as appropriate, placed on hold for the short duration during which signaling is transmitted on inside wiring of telephone line 187. Upon detection of the acknowledged signal by caller ID FSK generator 109, name and telephone data is transmitted over inside wiring of telephone line 187 to caller ID display 137 for display there and subsequently, telephones 133 and or 135 reconnect (as does NID 131) so as to reestablish communications with an outside party.

Subscriber line 185 connects NID 131 to service switching point (SSP) 151 of PSTN (public switched telephone network) 150. SSP 151 may be a conventional central office switch such as a Lucent 5ESS or Nortel DMS 100. As is understood by those skilled in the art, subscriber line 185 may include other segments and components of outside and inside plant including, for example, distribution panels, cross connects, digital loop carrier systems, etc. Further, while subscriber line 185 may provide conventional analog dialup POTS (plain old telephone service) including caller ID, the invention is also applicable to other services, signaling and protocols. For example, subscriber line 185 may provide ISDN service (in which case, incoming call information is provided as ANI), DSL (digital subscriber line) service, etc.

SSP 151 connects to switched telephone network 153 by appropriate trunks for transmitting and receiving telephone calls. Switched telephone network 153 provides connectivity to other facility use such as foreign SSP 153 and remote subscribers 175. Also interfacing with switch telephone network 153 are various cellular telephone system facilities 171 for establishing communications with cellular telephone 173.

SSP 151 also provides subscriber connectivity with router 157 for accessing internet service provider (ISP) 177 and Internet 179. Internet 179, in turn, provides wide area connectivity with a broad range of services such as telephone directory server 179 and database 183.

SSP 151 may further provide connectivity to intelligent peripheral (IP) 167 and mediated access to service control point (SCP) 163. IP 167 performs gate keeping and administrative services required to provide protected access and retrieval of data from database 165 including, for example, calling name (CNAM) information and/or the line information database (LIDB). The common channel signaling network SS7 161 provides access to IP 167 by way of signal transfer point (STP) 159. SS7 network 161 further provides connectivity with SCP 163 and database 165.

As is understood by one skilled in the art, for those subscribers having enhanced caller ID services including calling name, SSP 151 supplements caller ID telephone number information for calls terminating at the switch by launching a query to SCP 163. In response, SCP 163 returns CNAM information from database 165 to SSP 151 via STP 159 for transmission to called subscriber and display on caller ID display 137 and, according to the invention, processing by caller ID receiver/decoder 107 of ATDA 100. Further, according to the invention, this name lookup may be initiated by ATDA 100 to obtain CNAM information missing from local database 115. Preferably, ATDA 100 flags information missing from local database 115 and schedules an update. The update may be prompted when a sufficient number incomplete records or pieces of missing data are identified (e.g., three or more telephone numbers having missing names), and cues the records associated with affected telephone numbers for update during some period when connectivity may be established with a remote database. For example, ATDA 100 may be programmed to access and search remote databases to update database 115 during times when it is unlikely that the subscriber will be making or receiving telephone calls, e.g., between 2:00 and 4:00 a.m. ATDA 100 may also schedule synchronization of the subscriber's other personal directories during an appropriate time period or may initiate synchronization of databases opportunistically, such as when cellular telephone 173 is in communication with customer premises 130 so that synchronization may be performed. In the case of cellular telephone 173, an alternative synchronization procedure may include download of information from database 115 to cellular telephone system 171 and, subsequently, transfer of such data to cellular telephone 173 via, for example, transmission over a cellular control channel.

ATDA 100 supports three categories of operations: (i) incoming and outgoing call monitoring including detection of telephone number and name information, storage of information in database 115, and display of such information; (ii) maintenance or “synchronization” of database 115 with broad-based data bases including searching for and retrieval of missing data from external resources including remote databases; and (iii) synchronization of directory information stored in database 115 with the user's other personal directories maintained by other devices and systems such as database 143 and cellular telephone 173.

In operation, an income telephone call terminating at SSP 151 causes the switch to generate ringing signal onto subscriber line 185 which is then transmitted to telephones 133 and 135. During the four second interval after the first ring signal, SSP 151 transmits any caller ID information onto subscriber line 185 for display for caller ID display 137. At the same time, this information is captured by CLID receiver/decoder 107 and provided to Controller 101. Controller 101, in response searches database 115 for the decoded telephone number. If the telephone number is not found, it is then stored in database 115 together with the caller's name, if made available by caller ID. If name information is not available, Controller 101 flags the telephone number to obtain name information from a remote database at a later time. Conversely, if the telephone number is found, any name information provided by caller ID is compared with any previously stored name information contained in database 115. If the name information had not been previously stored, then name information from caller ID may be used to complete the record. Alternatively, conflicts between previously stored name information from database 115 and caller ID supplied name information may be resolved by an appropriate protocol. For example, both names may be stored or preference may be given to manually stored name data, etc.

In addition to database maintenance activities, the telephone number and, if made available or previously stored, the name may be displayed on display 117. To the extent that caller ID name information is not available and name or other information is stored in database 115, this information may be displayed locally on display 117 and transmitted for display to remote devices such as caller ID display 137 or server 141. Thus, in the case of server 141, Controller 110 transmits an appropriate data message via LAN interface 119 to LAN 139 for display at server 141. This information may also be transmitted, time permitting, during the four second period, to caller ID display 137 by caller ID FSK generator 109 via inside wiring of telephone line 187. Alternatively, this information may be passed to caller ID display 137 using the CIDCW protocol previously described.

In connection with an outgoing telephone call, off hook/dial tone detector 103 alerts controller 101 upon detecting an off-hook condition and/or the provision of dial tone by the central office in response to either telephone 133 or 135 going off hook. In response, controller 101 instructs DTMF receiver/decoder 105 to “collect digits”, that is, decode any subsequent string of DTMF signaling detected on inside wiring of telephone line 187. Limiting DTMF decoding to a predetermined period of time and/or number of digits received subsequent to detecting an off-hook condition and/or receipt of dial tone has the effect of minimizings the decoding of extraneous signals and/or DTMF signaling not associated with dialing. This also has the effect of minimizing unnecessary interrupts to controller 101 by DTMF receiver/decoder 105. Alternatively, if remote DTMF control of ATDA 100 is implemented, DTMF receiver/decoder 105 may be reactivated in response to receipt of an escape DTMF control sequence and/or access code. As a still further alternative, controller 101 may be programmed to recognize outgoing dialing signally during some predetermined period subsequent to receipt of dial tone and/or collection of a predetermined number of digits, while subsequent DTMF signaling may be ignored unless the appropriate escape control sequence is received.

Upon detection and decoding of a telephone number associated with an outgoing telephone call, processing continues as described in connection with an incoming telephone call. Thus, database 115 is searched for the telephone number which, if found, results in the display of the associated name, or, if not found, stores the telephone number and queues it for subsequent retrieval and storage of name information.

Maintenance of database 115 is performed by controller 101 in response to predetermined conditions, availability of communications to and with remote databases, time of day, etc. For example, access to subscriber line 185 and PSTN 150 may be limited by incoming calls received and outgoing calls placed by a user on telephones 133 and 135. In such case, telephone number records having missing or incomplete data may be queued for updating at a later time. Preferably, controller 101 records unsuccessful attempts to obtain missing information associated with particular telephone numbers so that, after a predetermined maximum number of such attempts, a “time out” will inhibit additional searches for the missing information. Controller 101 may still preferably maintain a record of databases searched for the missing information so that searching of previously unaccessed databases is not inhibited. Still further, controller 101 may schedule enhanced database maintenance to complete and/or verify information stored in or missing from database 115 including enhanced searching of resources. For example, controller 101 may schedule and initiate, during off hours, wide searches of resources available on internet 179 for missing information or information subject to verification. Searching of internet 179 may include use of search engine facilities supplied by various services and, in particular, search engines directed to telephone listings and having reverse look-up capabilities, i.e., allowing searches based on telephone number.

Upon completion of database maintenance, directory synchronization may be performed to conform data stored in related personal directories with that stored in database 115. In the case of on-line systems such as server 141 and associated database 143, synchronization may be scheduled, initiated as required (for example when a change is made to database 115), and/or initiated manually. In the case of devices which may not be available on a scheduled basis, updating and synchronization may be performed opportunistically. For example, cellular telephone 173 may be configured to synchronize an internally stored telephone directory with database 115 during times when communications is established with customer premises 130 and ATDA 110. Updates may also be provided to cellular telephone system 171 for transmission to cellular telephone 173 over a control channel as part of a login process performed by cellular telephone 173.

In addition to telephone control and data signals, ATDA includes voice processor 121 for handling spoken commands and information. For example, a user may manually supplement a telephone directory listing stored in database 115 by speaking the information, such as during or subsequent to a telephone conversation. Preferably, controller 101 and voice processor 121 are responsive to predetermined key words and/or DTMF or similar signaling to enable voice recognition and remote operation of the apparatus. Manual control and updating is further supported by a touch input capability of display 117 and/or an appropriate keyboard input (not shown).

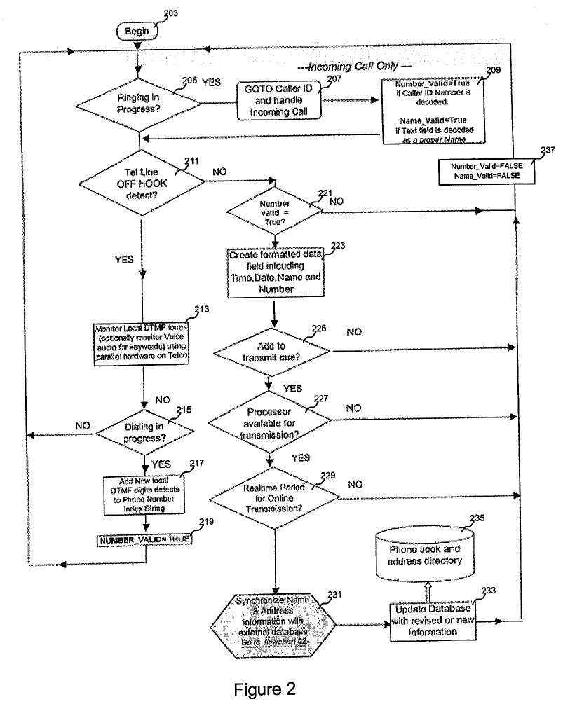

FIG. 2 is a flow chart of a procedure according to the invention for monitoring telephone calls on a subscriber line and updating a directory. After entering the process at 203, a check is performed at 205 to determine if ringing is in progress. If ringing is received, then processing continues at 207 where caller ID information is retrieved from the incoming call. At step 209 appropriate flags are set to indicate receipt of caller ID telephone and name information.

If ringing is not in progress or the incoming call processing of steps 207 and 209 has been completed, then processing continues to checking step 211 to see if a telephone line off hook condition is detected, indicative of initiation of an outgoing call. If an off hook condition is detected, then flow continues at step 213 to monitor local DTMF tones and/or, optionally, monitor voice audio for key words. At step 215, if dialing is in progress, then the digits are collected at step 217 and, at 219, the “NUMBER_VALID” flag is set to true, after which flow loops back to checking step 205. Conversely, if dialing is not in progress at step 215, digit collection is not performed and, again, flow continues back to step 205.

After all caller ID information associated with an incoming call, or all dial digits associated with an outgoing call, are collected, flow continues to step 221 to check if the NUMBER_VALID flag is true. That is, if no telephone number has been detected or if the number is invalid, then processing continues back to step 237 where the NUMBER_VALID flag is reset to false as is the NAME_VALID flag, and flow continues back to step 205 and continued looping is performed through steps 211,221, and 237 until a valid telephone number is detected.

Upon receipt of a valid telephone number, flow continues at step 223 to create a formatted data field including the time, date, name and telephone number. If the data field is complete and is properly stored in the directory at step 223, then the check at step 225 fails, there being no need to add the telephone number to the transmit queue and processing continues to loop back through step 237 to reenter at step 205. Conversely, if the data field as recorded in the directory at step 223 is complete, then the telephone number is added to the transmit queue at step 225 and flow continues at step 227 to check for the availability of a transmission media or path by the processor. If the processor is unavailable, then flow loops back through step 237 to reset the NUMBER_VALID and NAME_VALID flags to false and reenter at step 205. In this case, synchronization will be delayed until detection of a subsequent telephone number.

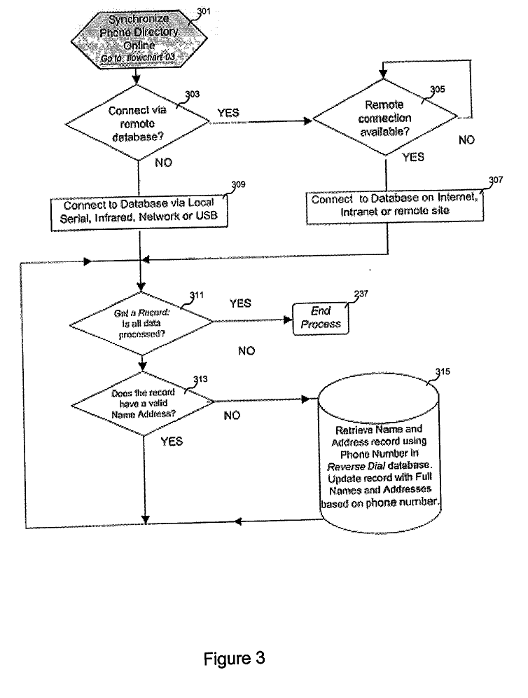

If, at step 227, the processor is available for transmission and the real time period check of 229 is passed so that online transmission may be performed, then flow continues at step 231 to synchronize the name and address information with an external database as will be detailed below in connection with FIG. 3. After synchronization, flow continues at step 233 to update the database 235 with revised or new information and processing flow loops back to, again, reenter at step 205. If, however, the real time period check at step 229 is failed, synchronization is not performed and processing loops back to step 205 to check for a subsequent telephone number. The END_PROCESS 237 indicates completion of a database update session.

FIG. 3 is a flow diagram showing synchronization required to obtain calling party name information associated with a telephone number from an external or remote database. Entering the process at 301, alternative databases may be selected at step 303. If a remote database is to be used, then flow continues to step 305 to loop until a remote connection is available. When available, connection to the remote database is accomplished at step 307 using, for example, the Internet, an intranet or a remote site. Alternatively, if a local database is to be used, then connectivity is established via a local serial, infrared, network or USB connection at step 309.

It is to be understood that the description of the preferred embodiment is not intended to limit the invention. Those of ordinary skill in the art will recognize that various alternatives are within the scope of the invention. Thus, one of ordinary skill will be able to effect various changes, substitutions of equivalents, and various other aspects of the invention as broadly disclosed herein. It is therefore intended that the protection granted herein be limited only by the definition contained in the appended claims and equivalents thereof.

It is further understood that any and all publications, patents, and patent applications mentioned in this specification are indicative of the level of skill of those skilled in the art to which this invention pertains. All publications, patents, and patent applications are herein incorporated by reference to the same extent as if each individual publication or patent application was specifically and individually indicated to be incorporated by reference.

I claim:

1. A method of managing a database, comprising the steps of:
monitoring telephone signals on a subscriber telephone line;
extracting, from said telephone signals, telephone number data associated with respective telephone calls;
searching, upon completion of said calls, a remote database containing identification data associated with said telephone number data; and
storing said identification data in association with said telephone number data in a directory.

2. The method of claim 1 further comprising a step of searching said directory for said identification data and, in response to an absence thereof, performing said step of searching said remote database.

3. The method of claim 1 wherein said step of monitoring includes one of (i) detecting a caller-ID signal of an incoming one of said calls and (ii) detecting a dialing signal associated with an outgoing one of said calls.

4. The method of claim 1 further comprising the steps of:
accumulating a plurality of telephone numbers to form said telephone number data;
determining an availability of a communications link with said remote database; transmitting said telephone number data to said remote database; and receiving said identification data from said remote database.

5. The method of claim 1 wherein said step of searching includes the steps of:
formulating a query message based on said telephone number data;
transmitting said query to said remote database; and
receiving a reply from said remote database including said identification data.

6. The method of claim 5 wherein said transmitting step includes formatting said query for transmission on the Internet.

7. The method of claim 1 wherein said step of monitoring includes:
detecting an incoming one of said calls;
decoding one of a caller-ID and ANI message transmitted in association with said incoming call;
detecting an outgoing one of said calls; and
decoding a dialing signal associated with said outgoing call.

8. The method of claim 1 further comprising a step of synchronizing a second database to agree with said identification and telephone number data stored in said directory.

9. The method of claim 1 further comprising recognizing a voice segment spoken on said telephone line and decode said voice segment to extract therefrom said telephone number data.

10. The method of claim 1 further comprising a step of displaying said identification data and said telephone number data.

11. A telephone directory system comprising:
an interface adapted for connecting to a subscriber line of a voice telephone network;
a dialing signal decoder receiving a dialing signal from said interface to provide dialed number information;
a calling number identification decoder receiving a calling number signal from said interface to provide calling number information;
a processor receiving said dialed and calling number information and, in response, issuing a query to a remote database for identification information associated with at least one of said dialed and calling number information; and
a memory storing said dialed and calling number information and said identification information.

12. The telephone directory system of claim 11 further comprising a connection to a data network, said processor transmitting said query to said remote database on said data network.

13. The telephone directory system of claim 11 further comprising a display connected to said processor and configured to display said dialed and calling number information and said identification information.

14. The telephone directory system of claim 11 wherein said processor is further configured to, in response to said calling number signal, initiate a search of said memory for said identification information.

15. The telephone directory system of claim 11 wherein said identification information includes names of parties associated with said dialed and calling number information.

16. The telephone directory system of claim 11 wherein said interface include a network interface device (NID);
said dialing signal decoder include a DTMF receiver/decoder;
said calling number identification decoder includes one of a (i) caller-ID and (ii) ANI decoder;
said dialed and calling number information each include telephone numbers of called and calling parties on said voice telephone network;
said identification information includes names associated with at least one of said called and calling parties; and
said telephone directory system further include a display configured to display to a user said telephone numbers of said called and calling parties and said name.

17. The telephone directory system of claim 16 further comprising a connection to a packet network for accessing said remote database.

18. The telephone directory system of claim 16 comprising a line status detector configured to determine an availability of said subscriber line for initiating a call to said remote database.

19. The telephone directory system of claim 16 further comprising a modulator configured to transmit said name to a remote caller-ID receiver.

20. A telephone number database comprising:
a DTMF receiver/decoder connected to a subscriber line to provide called number data;
a caller-ID receiver/decoder connected to the subscriber line to provide calling number and name data;
a data modem configured to communicate with a remote network including a remote database of telephone numbers and associated names;
a memory;
a controller configured to store said called and calling number data and said name data in said memory, said controller responsive to detection of a telephone call on said subscriber line for searching said memory for said name data corresponding to said telephone call; and further configured to transmit a query to said remote database for name information associated with said call.
